(19) United States
(12) Patent Application Publication
(10) Pub. No.: US 2017/0161090 A1
(43) Pub. Date: Jun. 8, 2017

(54) COMMUNICATION CONTROL PROGRAM, COMMUNICATION CONTROL METHOD, AND INFORMATION PROCESSING DEVICE

(71) Applicant: FUJITSU LIMITED, Kawasaki-shi (JP)

(72) Inventor: TAKESHI KODAMA, Yokohama (JP)

(73) Assignee: FUJITSU LIMITED, Kawasaki-shi (JP)

(21) Appl. No.: 15/334,926

(22) Filed: Oct. 26, 2016

(30) Foreign Application Priority Data
Dec. 8, 2015 (JP) 2015-239153

(51) Int. Cl. G06F 9/455; H04L 12/931

(52) U.S. Cl. CPC G06F 9/45558; H04L 49/70; G06F 2009/45595

(57) ABSTRACT

A communication control program for causing a computer to execute a process including: detecting setting of one-to-one communication between a first virtual machine and a second virtual machine generated in a common physical machine in configuration information including transmission destination information of communication data between ports of virtual switches; and setting, when the setting of the one-to-one communication is detected, a transmission buffer of the first virtual machine and a reception buffer of the second virtual machine to the same buffer area and setting a reception buffer of the first virtual machine and a transmission buffer of the second virtual machine to the same buffer area.

### CROSS-REFERENCE TO RELATED APPLICATION

This application is based upon and claims the benefit of priority of the prior Japanese Patent Application No. 2015-239153, filed on Dec. 8, 2015, the entire contents of which are incorporated herein by reference.

### FIELD

The present invention relates to a communication control program, a communication control method, and an information processing device.

### BACKGROUND

A plurality of virtual machines are activated, generated, and removed in a physical machine, e.g. a computer or a server, which is an information processing device, in order to construct various service systems. In this kind of physical machine, a desired network is constructed between a plurality of virtual machines and between a plurality of virtual machines and an external network by a virtual switch function which is based on software, in a kernel (host kernel) of an operating system (OS) of the physical machine.

In order to cope with virtualization software dynamically generating and removing a plurality of virtual machines, it is needed to dynamically generate and change the network of the virtual machine with a virtual switch function of a kernel.

In recent network industry, the network function is softwarized as described above (as a virtual network function (VNF)), and development of virtualization of network functions (NFV: network function virtualization) realized by virtual machines on a general-purpose server has progressed. According to an example of a form of NFV-based service provision, different virtual network functions are deployed in respective virtual machines. By using NFV, it is possible to transmit data received from an external network to a plurality of virtual machines in an order appropriate for the content of a service and to realize a flexible service.

Techniques related to networks and virtual switches are disclosed in Japanese Laid-open Patent Publication No. 2011-138397 and Japanese Laid-open Patent Publication No. 2015-76643, for example.

### SUMMARY

However, when the number of virtual machines increases due to reasons such as addition of a service to be provided or migration of a virtual machine, the traffic between virtual machines tends to increase. When the traffic between virtual machines increases, the load on a virtual switch function in a kernel increases and the kernel is highly likely to enter a heavy load state. Since a kernel has the function of a virtual switch between virtual machines and, moreover, a communication function of processes other than virtual switches, an increase in the load of the virtual switch function may affect other communication performances and a delay in a communication response and a packet loss may occur.

One aspect of the embodiment is a non-transitory computer-readable storage medium storing therein a communication control program for causing a computer to execute a process including: detecting setting of one-to-one communication between a first virtual machine and a second virtual machine generated in a common physical machine in configuration information including transmission destination information of communication data between ports of virtual switches; and setting, when the setting of the one-to-one communication is detected, a transmission buffer of the first virtual machine and a reception buffer of the second virtual machine to the same buffer area and setting a reception buffer of the first virtual machine and a transmission buffer of the second virtual machine to the same buffer area.

According to the aspect, it is possible to reduce the load on the virtual switch function.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a network function of a virtual machine formed by a virtual network function.

FIG. 2 is a diagram illustrating a first example of a virtual machine and a virtual network based on a virtual switch.

FIG. 3 is a diagram illustrating a second example of a virtual machine and a virtual network based on a virtual switch.

FIG. 4 is a diagram illustrating a third example of a virtual machine and a virtual network based on a virtual switch.

FIG. 5 is a diagram illustrating a fourth example of a virtual machine and a virtual network based on a virtual switch.

FIG. 6 is a diagram illustrating a configuration of a physical machine (server) which is an information processing device according to the present embodiment.

FIG. 7 is a diagram illustrating a configuration of a virtual machine and a host kernel HK of a physical machine according to the present embodiment.

FIG. 8 is a diagram illustrating a configuration of two virtual machines and a host kernel when a direct path is not set in FIG. 7.

FIG. 9 illustrates an example in which a direct path is set in correspondence to the present embodiment.

FIG. 10 is a flowchart illustrating the processes performed by the inter-VM direct path management program of the host kernel according to the present embodiment.

FIG. 11 is a diagram illustrating an example of an address conversion table of the transmission/reception queue.

FIG. 12 is a diagram illustrating an example of a virtual NIC information table.

FIG. 13 is a diagram illustrating an example of virtual network configuration information of a virtual bridge.

FIG. 14 is a flowchart of an event notification and interrupt generation function of a hypervisor according to the present embodiment.

FIG. 15 is a diagram illustrating an example of virtual network configuration information of a virtual switch.

### DESCRIPTION OF EMBODIMENTS

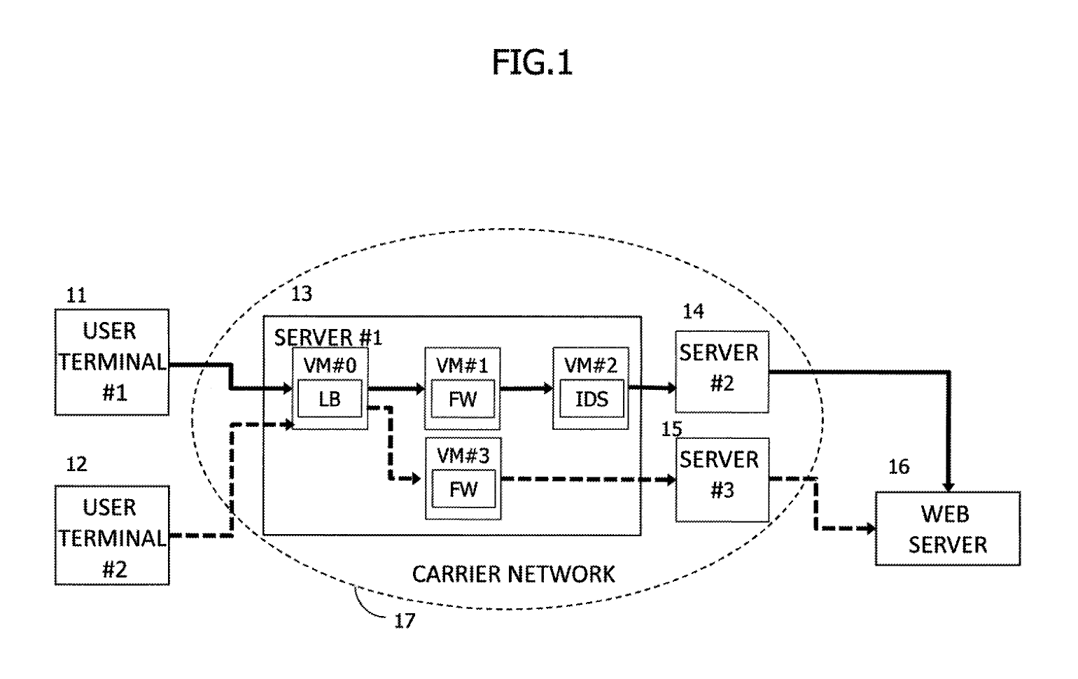

FIG. 1 is a diagram illustrating an example of a network function of a virtual machine formed by a virtual network function. FIG. 1 illustrates a configuration example in which a plurality of user terminals 11 and 12 access a web server 16 via a carrier network 17. Moreover, servers 13, 14, and 15 which are physical machines are disposed in the carrier network 17, and a plurality of virtual machines VM#0 to VM#3 are deploy in the server 13. A desired network is constructed in each of the four virtual machines deploy in the common server 13 by a virtual switch function included in the kernel of the OS of the server 13. As a result, as illustrated in FIG. 1, a packet is transmitted from the virtual machine VM#0 to the virtual machines VM#1 and VM#3, a packet is transmitted from the virtual machine VM#1 to the virtual machine VM#2, a packet is transmitted from the virtual machine VM#2 to another physical machine 14, and a packet can be transmitted from the virtual machine VM#3 to another physical machine 15.

For example, when a virtual machine VM#0 executes a load balancer LB program, virtual machines VM#1 and VM#3 execute a firewall FW program, and an instruction detection system is constructed in a virtual machine VM#2, the following operation is performed. That is, the virtual machines VM#0 evenly distributes access requests addressed to a web server 16 from user terminals to the virtual machines VM#1 and VM#3, the virtual machines VM#1 and VM3 perform firewall processing, and the virtual machine VM#2 detects unauthorized acts on a computer and a network based on the content of data and a procedure of data and delivers the access requests to the web server 16 via servers 14 and 15, respectively.

In FIG. 1, a one-to-one communication network is constructed between the virtual machines VM#1 and VM#2 generated in the same server 13. The one-to-one communication network is configured as a virtual switch constructed by a virtual network function included in the kernel of the server 13.

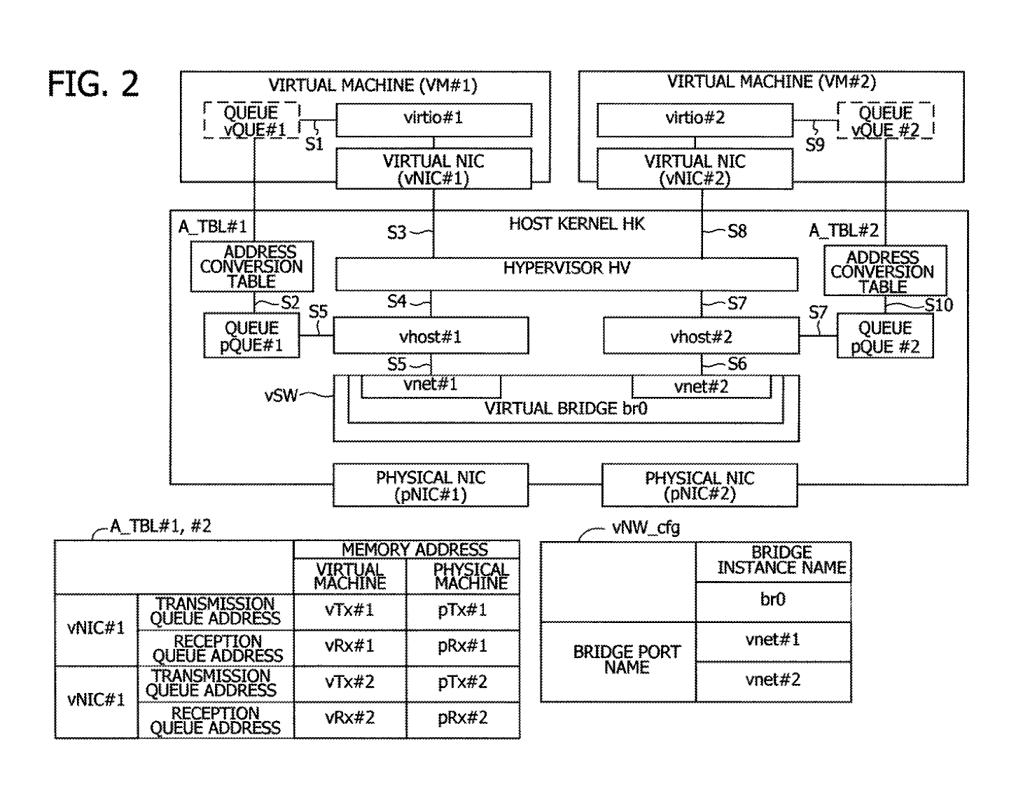

FIG. 2 is a diagram illustrating a first example of a virtual machine and a virtual network based on a virtual switch. In FIG. 2, two virtual machines VM#1 and VM#2 are generated in a physical machine (not illustrated). Specifically, a hypervisor HV activates and generates the virtual machines VM#1 and VM#2 based on virtual machine configuration information.

The virtual machines VM#1 and VM#2 have virtual network interface cards (vNIC, hereinafter referred to simply as virtual NICs) vNIC#1 and vNIC#2 configured in virtual machines, virtual device drivers (virtual IOs) virtio#1 and virtio#2 that drives the virtual NICs, and virtual transmission/reception queues vQUE#1 and vQUE#2 of the virtual device drivers. A virtual device driver controls transmission and reception of data via a virtual NIC.

Moreover, a host kernel HK of an OS of a host machine which is a physical machine forms a virtual switch vSW using a virtual switch function. The virtual switch is a virtual switch constructed by software in the host kernel of a physical machine, and is a virtual bridge which is an L2 switch, a virtual switch which is an L3 switch, or the like, for example. The virtual bridge maintains information on a port provided in a bridge instance.

In the example of FIG. 2, the virtual switch vSW is a virtual bridge instance br0 that forms a bridge that connects the virtual NICs of the virtual machines VM#1 and VM#2. The virtual switch vSW is constructed based on virtual network configuration information vNW_cfg, and the virtual network configuration information vNW_cfg in FIG. 2 has connection information between the ports of one virtual bridge instance br0. The virtual bridge instance br0 routes and transmits communication data by the control of the host kernel HK based on the connection information between the ports.

Furthermore, the host kernel HK has backend drivers vhost#1 and vhost#2 that exchange communication data between a virtual NIC and a virtual switch vSW and address conversion tables A_TBL#1 and A_TBL#2 between virtual queues vQUE#1 and vQUE#2 which are virtual transmission/receive queues of the virtual device drivers and physical queues pQUE#1 and pQUE#2 which are substantial transmission/reception queues of a physical machine. A physical transmission/reception queue is a type of FIFO queue, and an entity thereof is formed on a memory of a server. The virtual machines VM#1 and VM#2 use the physical transmission/reception queue mapped onto their own address space.

The hypervisor HV issues a transmission request to the backend drivers vhost#1 and vhost#2 upon detecting a data communication event from a virtual NIC, and issues a reception notification interrupt to a corresponding virtual NIC upon receiving a data reception notification from the backend driver.

According to the virtual network configuration information vNW_cfg, the virtual bridge instance br0 has two ports vnet#1 and vnet#2 only, and these ports are connected to virtual NICs of virtual machines, respectively (that is, port names vnet#1 and vnet#2 are connected to virtual NICs). Therefore, in the example of FIG. 2, the virtual NIC (vNIC#1) of the virtual machine VM#1 and the virtual NIC (vNIC#2) of the virtual machine VM#2 perform one-to-one communication. That is, transmission data from the virtual NIC (vNIC#1) of the virtual machine VM#1 is received by the virtual NIC (vNIC#2) of the virtual machine VM#2. In contrast, transmission data from the virtual NIC (vNIC#2) of the virtual machine VM#2 is received by the virtual NIC (vNIC#1) of the virtual machine VM#1. The virtual switch vSW constructs a virtual network that directly connects the virtual NIC (vNIC#1) of the virtual machine VM#1 and the virtual NIC (vNIC#2) of the virtual machine VM#2. This example corresponds to a network between the virtual machines VM#1 and VM#2 of FIG. 1.

An outline of a communication process from the virtual machine VM#1 to the virtual machine VM#2 via the virtual switch vSW illustrated in FIG. 2 will be described below.

(S1) The data transmission-side virtual machine VM#1 issues a data transmission request to the virtual device driver virtio#1 of the virtual NIC (vNIC#1) that transmits data and the virtual device driver writes transmission data to the virtual transmission/reception queue vQUE#1.

(S2) The host kernel HK converts the address of a virtual machine indicating a write destination of transmission data to the address of a physical machine by referring to the address conversion table A_TBL#1 and writes the transmission data to the transmission/reception queue pQUE#1 in the physical machine.

(S3) The transmission-side virtual device driver virtio#1 writes the transmission data and outputs a transmission notification via the virtual NIC (vNIC#1).

(S4) In response to the transmission notification, the hypervisor HV outputs a transmission event to the backend driver vhost#1 corresponding to the virtual NIC (vNIC#1) to request a transmission process.

(S5) The backend driver vhost#1 acquires data from the transmission/reception queue pQUE#1 of the physical machine and outputs the data to the virtual switch vSW.

(S6) The virtual switch vSW determines the output destination port vnet#2 of the transmission data based on the virtual network configuration information vNW_cfg and delivers data to the backend driver vhost#2 connected to the determined output destination port vnet#2. The operation of the virtual switch vSW (virtual bridge br0) is executed by virtual switch software of the host kernel HK.

(S7) The backend driver vhost#2 writes data to the transmission/reception queue pQUE#2 of the physical machine corresponding to the virtual NIC (vNIC#2) connected to the port vnet#2 and transmits a reception notification to the hypervisor HV.

(S8) The hypervisor HV issues a data reception notification interrupt to the virtual machine VM#2 having the virtual NIC (vNIC#2) corresponding to the backend driver vhost#2.

(S8, S9) The virtual device driver virtio#2 of the reception-side virtual NIC issues a request to read reception data from the virtual transmission/reception queue vQUE#2, and acquires data from the physical transmission/reception queue pQUE#2 of the physical machine, the physical address of which is converted from the virtual address of vQUE#2 based on the address conversion table A_TBL_#2.

FIG. 2 illustrates the virtual NIC (vNIC#1)-side address conversion table A_TBL#1 and the virtual NIC (vNIC#2)-side address conversion table A_TBL#2. In the virtual NIC (vNIC#1)-side address conversion table A_TBL#1, a transmission queue address vTx#1 and a reception queue address vRx#1 of the virtual machine VM#1 and a transmission queue address pTx#1 and a reception queue address pRx#1 of the physical machine are stored. Similar addresses are stored in the virtual NIC (vNIC#2)-side address conversion table A_TBL#2.

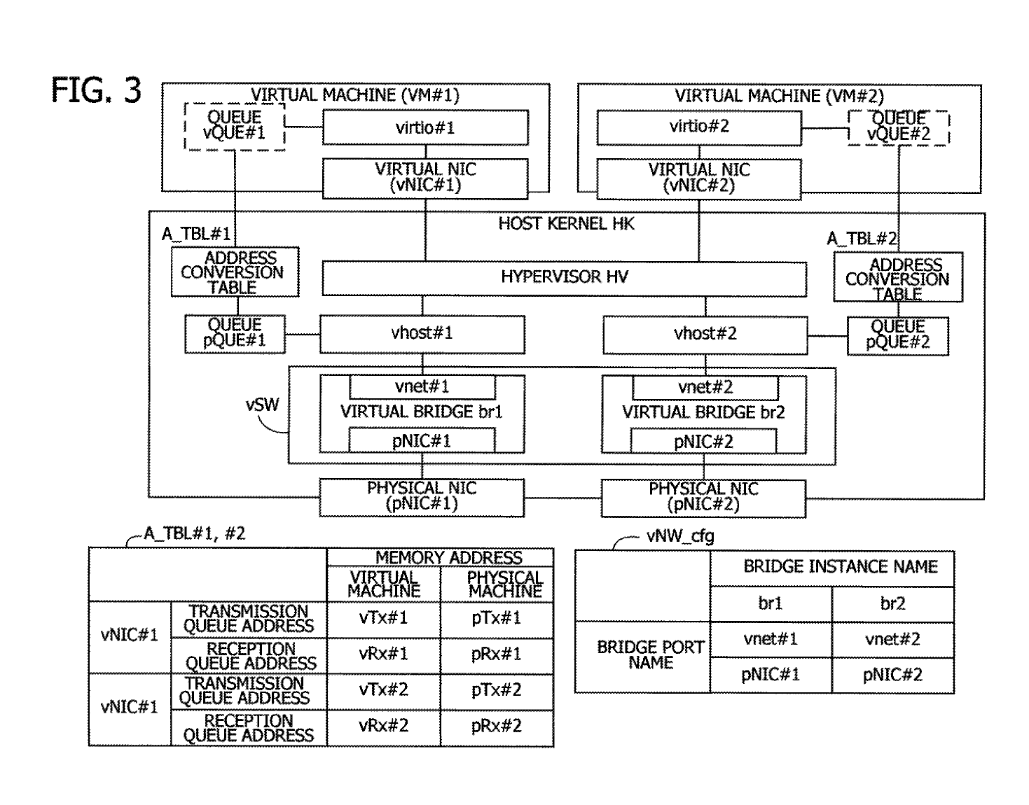

FIG. 3 is a diagram illustrating a second example of a virtual machine and a virtual network based on a virtual switch. In FIG. 3, unlike FIG. 2, the virtual switch vSW has a bridge instance br1 that connects the virtual NIC (vNIC#1) of the virtual machine VM#1 and the physical NIC (pNIC#1) and a bridge instance br2 that connects the virtual NIC (vNIC#2) of the virtual machine VM#2 and the physical NIC (pNIC#2). The other configuration is the same as that of FIG. 2.

The virtual network configuration information vNW_cfg that defines a configuration of a virtual switch vSW has the port information of two bridge instances br1 and br2. The bridge instance br1 has port names vnet#1 and pNIC#1, the port name vnet#1 means that the port vnet#1 is connected to the virtual NIC (vNIC#1), and the port name pNIC#1 means that the port pNIC#1 is connected to the physical pNIC#1. Similarly, the bridge instance br2 has port names vnet#2 and pNIC#2, the port name vnet#2 means that the port vnet#2 is connected to the virtual NIC (vNIC#2), and the port name pNIC#2 means that the port pNIC#2 is connected to the physical pNIC#2. These bridge instances are a type of L2 switches. However, since these bridge instances have only two ports, the bridge instances are bridges that perform one-to-one communication between vNIC#1 and vNIC#2 of the virtual machines VM#1 and VM#2 and the physical NICs pNIC#1 and pNIC#2 respectively.

In the above example, the port name specifies the port of a bridge and whether an NIC is a virtual NIC or a physical NIC is distinguished by the port name. Moreover, the physical NIC is connected to an external network (not illustrated).

With this bridge instance br1, transmission data and reception data are transmitted and received between the virtual NIC (vNIC#1) and the physical NIC (pNIC#1) of the virtual machine VM#1. That is, when the virtual machine VM#1 transmits a data transmission request to the virtual device driver virtio#1 of the virtual NIC (vNIC#1) that transmits data, the transmission data from the backend driver vhost#1 is output to the physical NIC (pNIC#1). In contrast, when the physical NIC (pNIC#1) receives data, a notification is transmitted to the virtual NIC (vNIC#1) of the virtual machine VM#1 via the backend driver vhost#1 and the reception data is received by the virtual device driver virtio#1.

Transmission and reception of data by the bridge instance br2 is the same as that of the bridge instance br1.

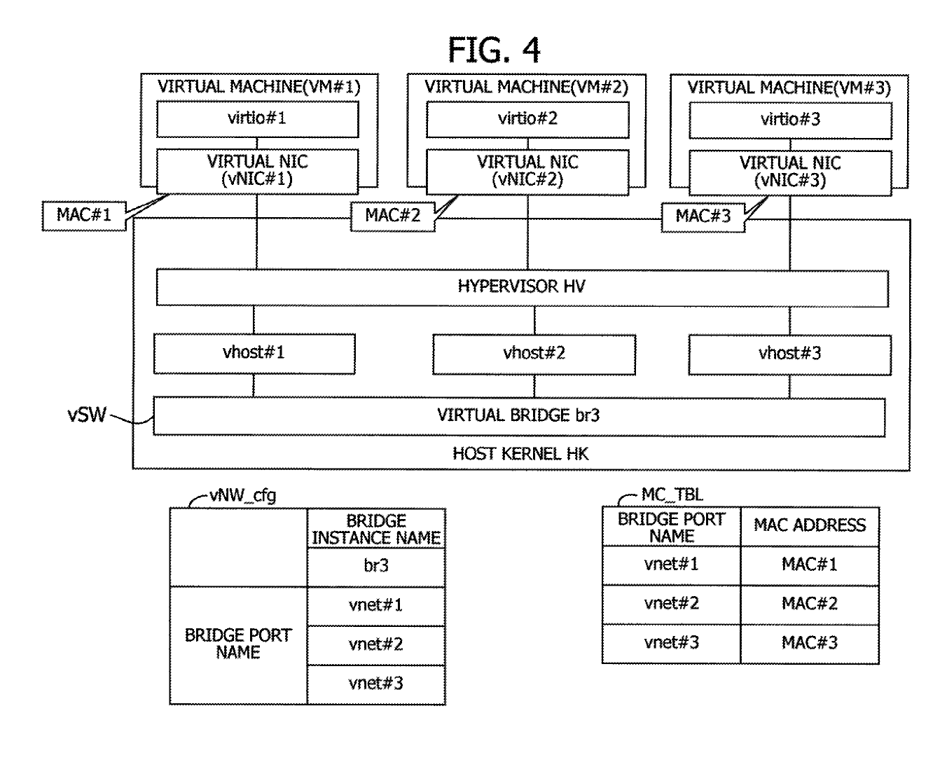

FIG. 4 is a diagram illustrating a third example of a virtual machine and a virtual network based on a virtual switch. In the third example of FIG. 4, three virtual machines VM#1, VM#2, and VM#3 are activated (generated) and operating in a physical machine (not illustrated). The virtual NICs (vNIC#1, vNIC#2, and vNIC#3) of these virtual machines are connected to the backend drivers vhost#1, vhost#2, and vhost#3 of the host kernel HK via the hypervisor HV. Moreover, a virtual bridge (L2 switch) br3 constructs a virtual network vNW between these virtual NICs. In general, the L2 switch is referred to as a bridge. Moreover, an L3 switch described later is referred to as a switch.

The virtual network configuration information vNW_cfg illustrated in FIG. 4 has configuration information of a bridge instance br3 of the virtual bridge br3. According to this information, the bridge instance br3 has three ports vnet#1, vnet#2, and vnet#3. Furthermore, a MAC address table MC_TBL defines MAC addresses MAC#1, MAC#2, and MAC#3 of virtual NICs connected to the ports vnet#1, vnet#2, and vnet#3 of each bridge. Therefore, the virtual network vNW illustrated in FIG. 4 outputs a transmission packet input to each port to a port corresponding to a transmission destination MAC address by referring to the MAC address table MC_TBL.

In the third example of FIG. 4, the virtual network vNW is an L2 switch that routes three virtual NICs based on the transmission destination MAC address rather than performing one-to-one communication between a pair of virtual NICs unlike the first example of FIG. 2.

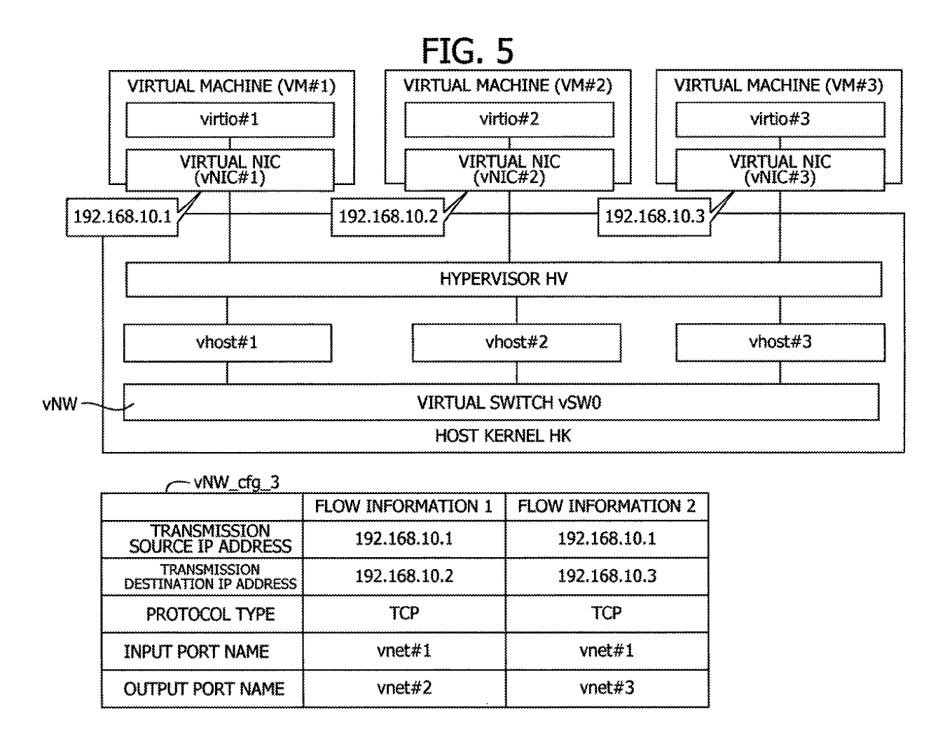

FIG. 5 is a diagram illustrating a fourth example of a virtual machine and a virtual network based on a virtual switch. In the fourth example of FIG. 5, similarly to FIG. 4, three virtual machines VM#1, VM#2, and VM#3 are activated and generated in a physical machine, and a virtual network vNW between the virtual NICs (vNIC#1, vNIC#2, and vNIC#3) of these virtual machines is constructed by a virtual switch vSW0. The virtual NICs (vNIC#1, vNIC#2, and vNIC#3) of the virtual machines each have an IP address illustrated in the drawing. That is, the virtual switch vSW0 has an IP address 192.168.10.x with respect to an external network and three virtual NICs (vNIC#1, vNIC#2, and vNIC#3) in a virtual network vNW based on the virtual switch vSW0 have different IP addresses 192.168.10.1, 192.168.10.2, and 192.168.10.3, respectively.

The virtual switch vSW0 that forms the virtual network vNW is an L3 switch that determines an output destination port of an input packet and routes the packet according to an input port and an output port of a virtual network configuration information vNW_cfg_3 and flow information of a packet having a protocol type (TCP), a transmission source IP address, and a transmission destination IP address.

The virtual network configuration information vNW_cfg_3 illustrated in FIG. 5 has an input port name vnet#1 (a port connected to the virtual NIC (vNIC#1)), an output port name vnet#2 (a port connected to the virtual NIC (vNIC#2)), a transmission source IP address 192.168.10.1, and a transmission destination IP address 192.168.10.2 as flow information 1. According to the flow information 1, the virtual switch vSW0 routes a packet having the transmission source IP address 192.168.10.1 and the transmission destination IP address 192.168.10.2 input to the input port vnet#1 to the output port vnet#2. Similarly, according to flow information 2, the virtual switch vSW0 routes a packet having the transmission source IP address 192.168.10.1 and the transmission destination IP address 192.168.10.3 input to the input port vnet#1 to an output port vnet#3.

Therefore, the virtual switch vSW0 is a switch having path 1 from vNIC#1 to vNIC#2 and path 2 from vNIC#1 to vNIC#3 between the virtual NICs (vNIC#1, vNIC#2, and vNIC#3) of the three virtual machines VM#1, VM#2, and VM#3, and is not a virtual switch that performs a one-to-one communication as illustrated in FIG. 2.

On the other hand, when the virtual network configuration information vNW_cfg_3 has only one of two flow information illustrated in FIG. 5, the virtual switch vSW0 is a virtual switch that performs such one-to-one communication as illustrated in FIG. 2.

[Problems of Virtual Switch]

As described above, a virtual switch that forms a virtual network has the configuration of either the L2 switch (bridge) or the L3 switch. Moreover, the virtual switch executes packet switching control with the aid of a virtual switch program included in the host kernel HK.

Therefore, when the number of virtual machines generated in a physical machine increases, the load on the host kernel HK increases. The host kernel HK controls virtual switches based on other processes as well as a virtual switch that forms a virtual network of a virtual machine. Therefore, it is needed to reduce the load on the host kernel HK in relation to controlling the virtual network and the virtual switch.

### Embodiment

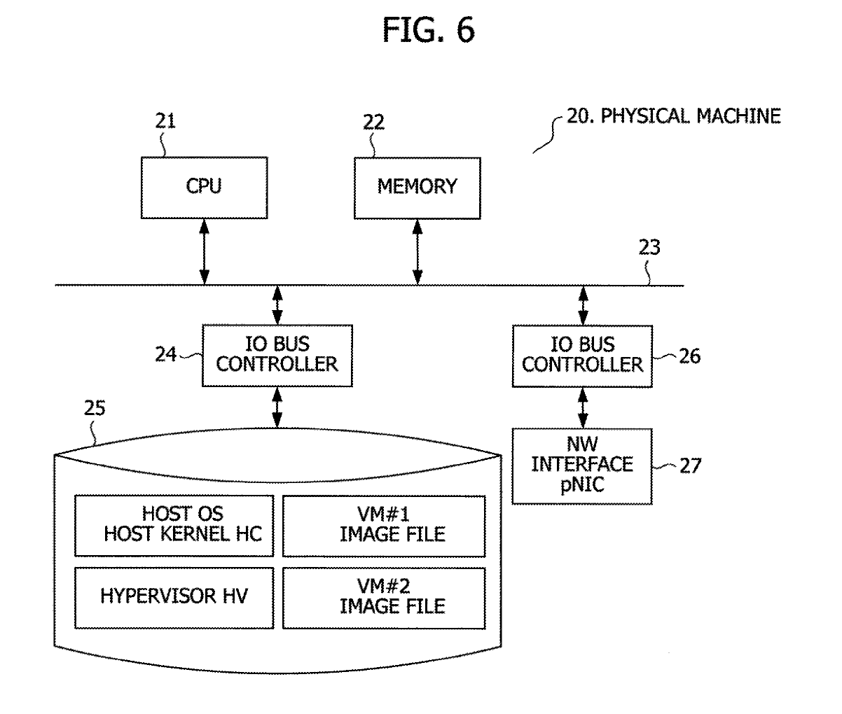

FIG. 6 is a diagram illustrating a configuration of a physical machine (server) which is an information processing device according to the present embodiment. A physical machine 20 illustrated in FIG. 6 is the server 13 illustrated in FIG. 1, for example. The physical machine 20 illustrated in FIG. 6 has a processor (CPU) 21, a main memory 22, a bus 23, an IO bus controller 24, a large volume nonvolatile auxiliary memory 25 like a HDD connected to the IO bus controller 24, an IO bus controller 26, and a network interface (physical NIC) pNIC 27 connected to the IO bus controller 26.

The auxiliary memory 25 stores a host operating system (OS) having a host kernel HK and a hypervisor HV which is virtualization software that activates and removes a virtual machine. The processor 21 loads the host OS and the hypervisor HV onto the main memory 22 and executes same. Moreover, the auxiliary memory 25 stores image files of the virtual machines VM#1 and VM#2 that are activated and generated by the hypervisor HV. The hypervisor HV activates a guest OS in the image file of the virtual machine according to an activation instruction from a management server (not illustrated) or a management terminal (not illustrated) and activates the virtual machine.

The image file of the virtual machine includes an application program or the like that is executed by the guest OS or the virtual machine, and the guest OS has a virtual device driver, a virtual NIC corresponding thereto, or the like.

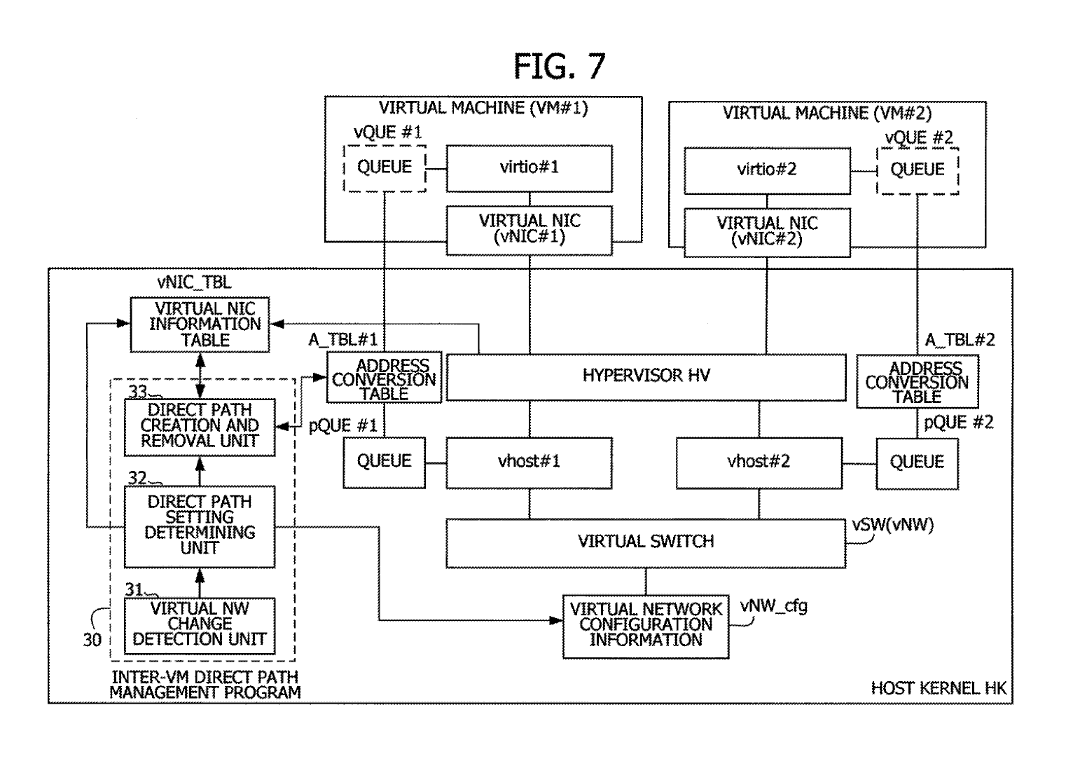

FIG. 7 is a diagram illustrating a configuration of a virtual machine and a host kernel HK of a physical machine according to the present embodiment. In the example of FIG. 7, two virtual machines VM#1 and VM#2 are generated in a physical machine (not illustrated). The virtual machine VM#1 has a virtual device driver virtio#1, a virtual NIC (vNIC#1) thereof, and a virtual queue (virtual transmission/reception buffer) vQUE#1. Similarly, the virtual machine VM#2 has a virtual device driver virtio#2, a virtual NIC (vNIC#2) thereof, and a virtual queue (virtual transmission/reception buffer) vQUE#2.

As described in FIG. 2, a virtual NIC is a virtual network interface card formed in a virtual machine, and a virtual device driver virtio is a device driver on virtual machines, that controls transmission and reception of data via a virtual NIC. Moreover, the virtual queue is a virtual queue and corresponds to an address on a virtual machine.

A hypervisor HV activates, controls, and removes a virtual machine on a physical machine. The hypervisor HV controls an operation between a virtual machine and a physical machine. The hypervisor HV in FIG. 7 has an event notification function of issuing a transmission request to a backend driver vhost in a physical machine-side host kernel HK in response to a transmission request from a virtual NIC and an interrupt generation function of generating a reception notification interrupt to a corresponding virtual NIC upon receiving a data reception notification from the backend driver. The backend driver vhost is generated for each virtual NIC of the virtual machine.

Moreover, in the present embodiment, the event notification function and the interrupt generation function of the hypervisor HV generate a reception notification interrupt directly to a counterpart virtual NIC of the path rather than issuing a transmission request to a backend driver upon detecting transmission of data from a virtual NIC in which a direct path between virtual NICs is set.

On the other hand, when a virtual device driver virtio of a virtual machine writes transmission data to a transmission queue (transmission buffer) of a virtual queue vQUE using an address on the virtual machine, the host kernel HK converts the address on the virtual machine to an address on a physical machine based on the address conversion table A_TBL and writes the transmission data to the transmission queue (transmission buffer) of the physical queue pQUE secured in a shared memory in the physical machine. In contrast, when the backend driver vhost writes reception data to the physical queue pQUE and outputs a reception notification to the hypervisor HV, the interrupt generation function of the hypervisor HV issues a reception interrupt to the virtual NIC, and the virtual device driver virtio reads the reception data in the reception queue of the virtual queue vQUE. When the virtual device driver reads the reception data in vQUE, the host kernel HK converts the address on the virtual machine to the address on the physical machine based on the address conversion table A_TBL. As a result, the virtual device driver acquires the reception data in the physical queue.

The virtual switch vSW is a virtual switch formed or realized by a program in the host kernel HK. The virtual switch vSW illustrated in FIG. 7 is connected to the virtual NIC (vNIC#1) of the virtual machine VM#1 and the virtual NIC (vNIC#2) of the virtual machine VM#2. The configuration of the virtual switch is set in the virtual network configuration information vNW_cfg. Various examples of the virtual network configuration information vNW_cfg are illustrated in FIGS. 2 to 5.

The configuration information of each virtual NIC is set in a virtual NIC information table vNIC_TBL. As will be described later, the virtual NIC information table virtual vNIC_TBL has an identifier of a corresponding backend driver of each virtual NIC, a port name (port identifier) connected to a virtual switch, an address of a physical queue secured in a memory area in a physical machine allocated to each virtual NIC, an identifier of a counterpart virtual NIC of a direct path set to each virtual NIC, and the like.

The host kernel HK of the present embodiment has an inter-VM direct path management program 30. The inter-VM direct path management program 30 has a virtual network change detection unit 31 that detects a change in a virtual network, a direct path setting determining unit 32 that determines whether a direct path is set between two virtual machines from the changed configuration information of the virtual network, and a direct path creation and removal unit 33 that creates a direct path when setting of a direct path is newly created according to a determination result obtained by the direct path setting determining unit and removes the direct path when the setting of an existing direct path is changed and the direct path disappears.

The inter-VM direct path management program 30 will be described later.

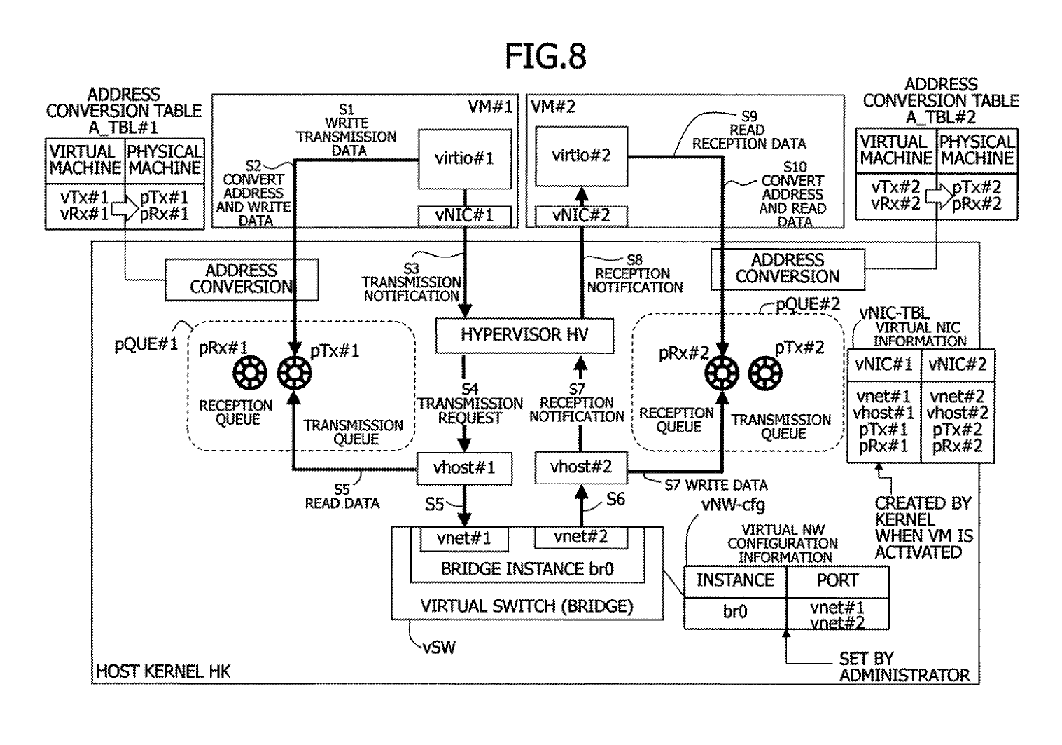

FIG. 8 is a diagram illustrating a configuration of two virtual machines and a host kernel when a direct path is not set in FIG. 7. The address conversion tables A_TBL#1 and A_TBL#2 in FIG. 8 and the port name of the bridge instance br0 of the virtual network configuration information vNW_cfg are the same as those of FIG. 2. However, in FIG. 8, the virtual NIC information table vNIC_TBL is illustrated. Moreover, in FIG. 8, a transmission queue (transmission buffer) and a reception queue (reception buffer) are illustrated in physical transmission/reception queues (transmission/reception buffers) pQUE#1 and pQUE#2 together with the addresses pTx#1, vRx#1, pTx#2, and vRx#2 of the physical machines, and a virtual transmission/reception queue is not illustrated since the queue is not actually written.

The information on the virtual NIC (vNIC#1) of the virtual machine VM#1 and the virtual NIC (vNIC#2) of the virtual machine VM#2 is set to the virtual NIC information table vNIC_TBL. According to the example of FIG. 8, the information on the virtual NIC (vNIC#1) includes a port identifier vnet#1 of the virtual switch vSW corresponding to the virtual NIC (vNIC#1), an identifier vhost#1 of the corresponding backend driver, and memory addresses pTx#1 and pRx#1 of the physical machine of the transmission/reception queue.

In FIG. 8, a direct path is not set in the virtual NIC information table vNIC_TBL, and communication is executed between the virtual NIC (vNIC#1) of the virtual machine VM#1 and the virtual NIC (vNIC#2) of the virtual machine VM#2 by the same operation as FIG. 2. The operation is the same as that described in FIG. 2. In FIG. 8, steps S1 to S10 illustrated in FIG. 2 are illustrated.

In particular, when the virtual device driver virtio#1 of the virtual machine VM#1 writes transmission data to a transmission queue, the host kernel HK converts the address vTx#1 of the virtual transmission queue, which is a write destination, of a virtual machine VM#1 to the address pTx#1 of the transmission queue of the physical machine and writes the transmission data to the transmission queue of the physical transmission/reception queue pQUE#1. As described above, this transmission/reception queue is an area in the main memory in the physical machine.

After that, when the backend driver vhost#1 reads transmission data from the transmission queue (the address pTx#1) and transmits the transmission data to the backend driver vhost#2 of the virtual NIC (vNIC#2) via the bridge instance br0, the backend driver vhost#2 writes the transmission data to the reception queue (the address pRx#1) of the physical transmission/reception queue pQUE#2. When the virtual device driver virtio#2 of the virtual machine VM#2 reads reception data using the address vRx#2 of the virtual machine in response to the reception notification S8, the host kernel HK converts the address vRx#2 to the address pRx#2 of the physical machine and reads the reception data from the physical reception queue, and the virtual machine VM#2 receives the reception data.

When data is transmitted from the virtual machine VM#2 to the virtual machine VM#1, an operation reverse to the above-described operation is performed.

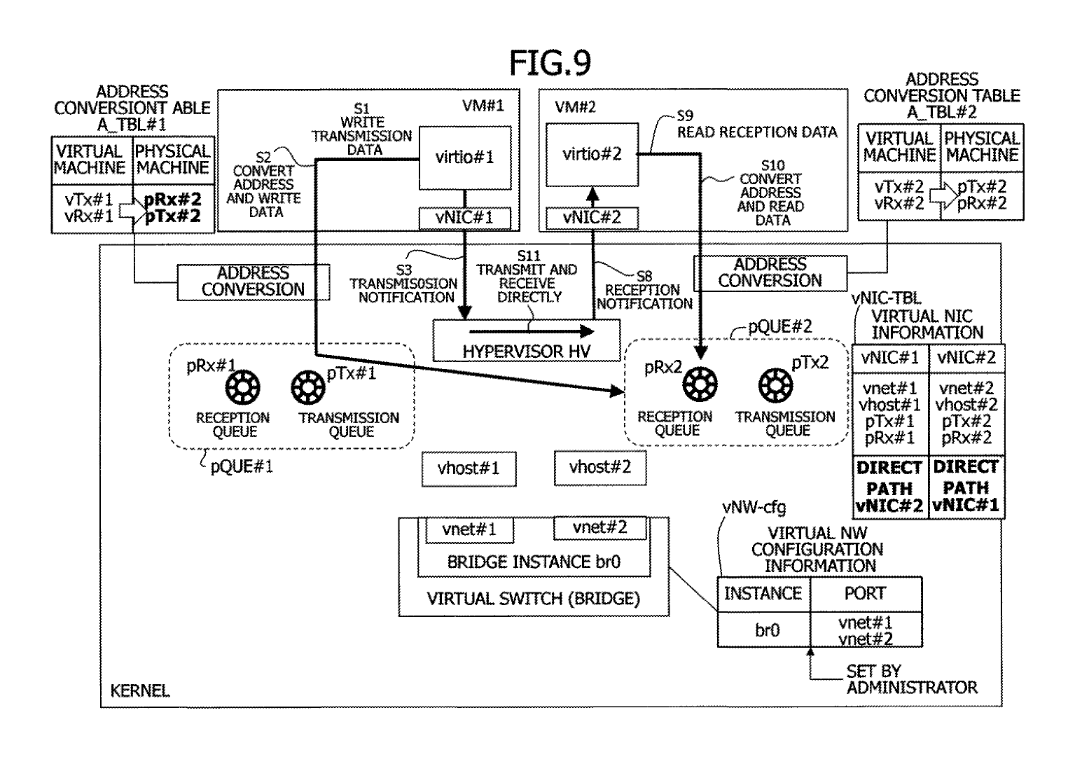

FIG. 9 illustrates an example in which a direct path is set in correspondence to the present embodiment. Hereinafter, an outline of the operation of the inter-VM direct path management program 30 (FIG. 7) of the present embodiment will be described with reference to FIG. 9.

That is, the virtual network change detection unit 31 monitors a command input by an administrator of a service system or the like formed by a virtual machine and notifies the direct path setting determining unit 32 of the content of a command upon detecting a command to change the virtual network configuration information vNW_cfg of the virtual switch vSW. In response to this, the direct path setting determining unit 32 determines whether one-to-one communication between virtual machines is set by referring to the virtual network configuration information vNW_cfg which is a change target of the command.

The determination condition includes that (1) only two ports are provided in a change target bridge instance and (2) the two ports of (1) are connected to two virtual NICs respectively (that is, a port name like vnet indicates that the port is connected to a virtual NIC). When a change target is an L3 switch, two port names appear only once each in the flow information which is the path information of the L3 switch and the two ports are input and output ports and are connected to virtual NICs, respectively. These conditions will be described in detail later.

When one-to-one communication is set, the direct path creation and removal unit 33 rewrites the address conversion table A_TBL#1 (or A_TBL#2, or both) so that virtual machines VM#1 and VM#2 in which one-to-one communication is set share one physical transmission/reception queue. In the example of FIG. 9, a physical transmission/reception queue pQUE#2 of the virtual machine VM#2 is shared between the virtual machines VM#1, VM#2. Due to this, the address of the physical machine in the address conversion table A_TBL#1 of the virtual machine VM#1 is changed to a reception queue address pRx#2 and a transmission queue address pTx#2 of the physical transmission/reception queue pQUE#2 of the virtual machine VM#2. That is, the address conversion table is changed so that the transmission and reception addresses are reversed differently.

When the physical transmission/reception queue pQUE#1 of the virtual machine VM#1 is shared, the address of the physical machine in the address conversion table A_TBL#2 of the virtual machine VM#2 is changed to a reception queue address pRx#1 and a transmission queue address pTx#1 of the physical transmission/reception queue pQUE#1 of the virtual machine VM#1. The transmission queue (pTx#1) of the virtual machine VM#1 and the reception queue (pRx#2) of the virtual machine VM#2 may be shared between the virtual machines VM#1 and VM#2. Moreover, the reception queue (pRx#1) of the virtual machine VM#1 and the transmission queue (pTx#2) of the virtual machine VM#2 may be shared between the virtual machines VM#1 and VM#2.

Furthermore, the direct path creation and removal unit 33 sets the identifiers vNIC#2 and vNIC#1 of the counterpart virtual NICs of the direct path to the virtual NIC information tables vNIC_TBL of the virtual NICs (vNIC#1 and vNIC#2). In this way, the hypervisor HV can enable one-to-one communication between two virtual NICs without using the virtual switch of the host kernel, which will be described in detail below.

According to the present embodiment, upon receiving a transmission notification from the virtual NIC (vNIC#1) (S3), the hypervisor HV checks whether the identifier of the counterpart virtual NIC of the direct path is set to the virtual NIC (vNIC#1) which is the source of the transmission notification by referring to the virtual NIC information table vNIC_TBL (S11). In the case of FIG. 9, since the counterpart virtual NIC (vNIC#2) of the direct path is set in the virtual NIC configuration table of the virtual NIC (vNIC#1), the hypervisor HV issues a reception notification interrupt to the counterpart virtual NIC (vNIC#2) of the direct path (S8).

In this case, writing of transmission data by the virtual device driver virtio#1 of the virtual machine VM#1 is performed on the reception queue (pRx#2) of the shared physical transmission/reception queue pQUE#2 based on the changed address conversion table A_TBL#1. Therefore, the virtual device driver virtio#2 of the virtual machine VM#2 having received the reception notification interrupt can read the reception data from the physical reception queue pRx#2.

In this manner, by setting the direct path between the virtual machines VM#1 and VM#2, transmission data addressed to the virtual machine VM#2, transmitted from the virtual machine VM#1 does not pass through the virtual switch vSW. Therefore, the host kernel HK does not need to control the operation of the virtual switch vSW, and the load on the host kernel HK can be reduced. Since the communication between the virtual machines VM#1 and VM#2 is controlled by the hypervisor HV and is performed directly between virtual machines, a control process by the host kernel HK of the physical machine is not required.

On the other hand, when a command, issued from an administrator, to change the setting of the virtual network configuration information vNW_cfg of a virtual switch involves removing one-to-one communication, the direct path creation and removal unit 33 restores the address conversion table A_TBL#1 to an original state and removes the setting of the direct path in the virtual NIC configuration table vNIC_TBL. In this way, the transmission data is transmitted to a transmission destination via a virtual switch vSW controlled by the host kernel HK.

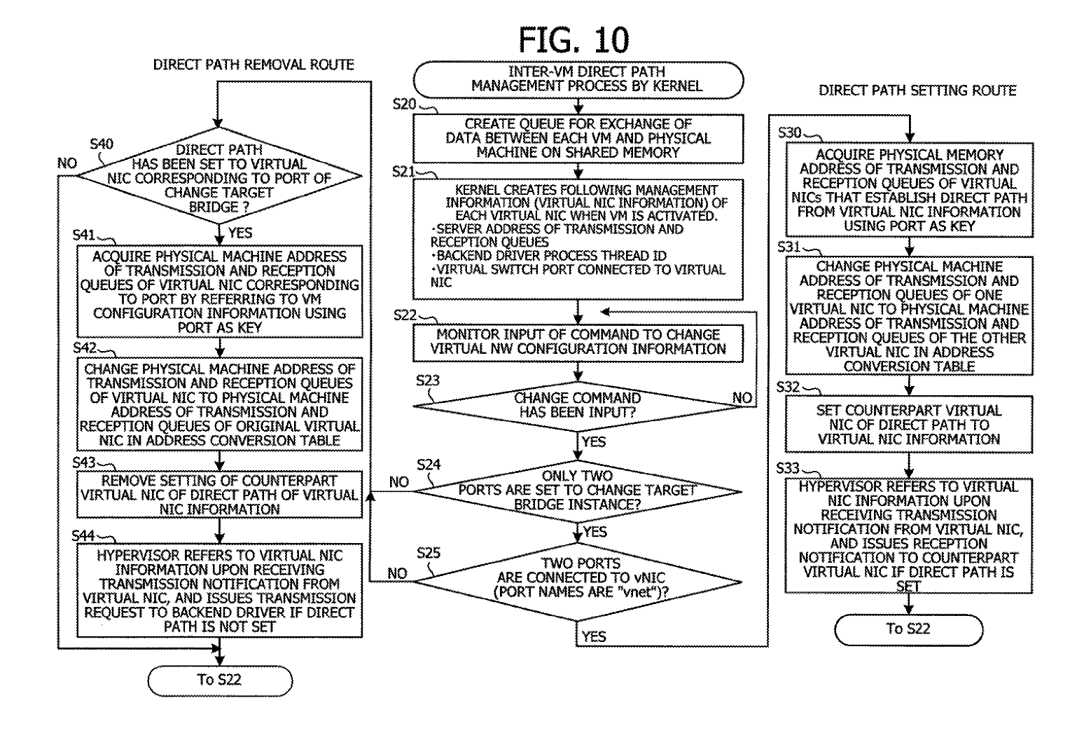

FIG. 10 is a flowchart illustrating the processes performed by the inter-VM direct path management program of the host kernel according to the present embodiment. FIG. 10 illustrates a case of setting a direct path and a case of removing the direct path. Hereinafter, a process of setting the direct path will be described.

[Direct Path Setting Process]

As a preliminary process, when virtual machines are activated, the host kernel HK creates a transmission/reception queue for exchange of transmission data and reception data between each virtual machine VM and a physical machine in a shared memory of the physical machine (S20).

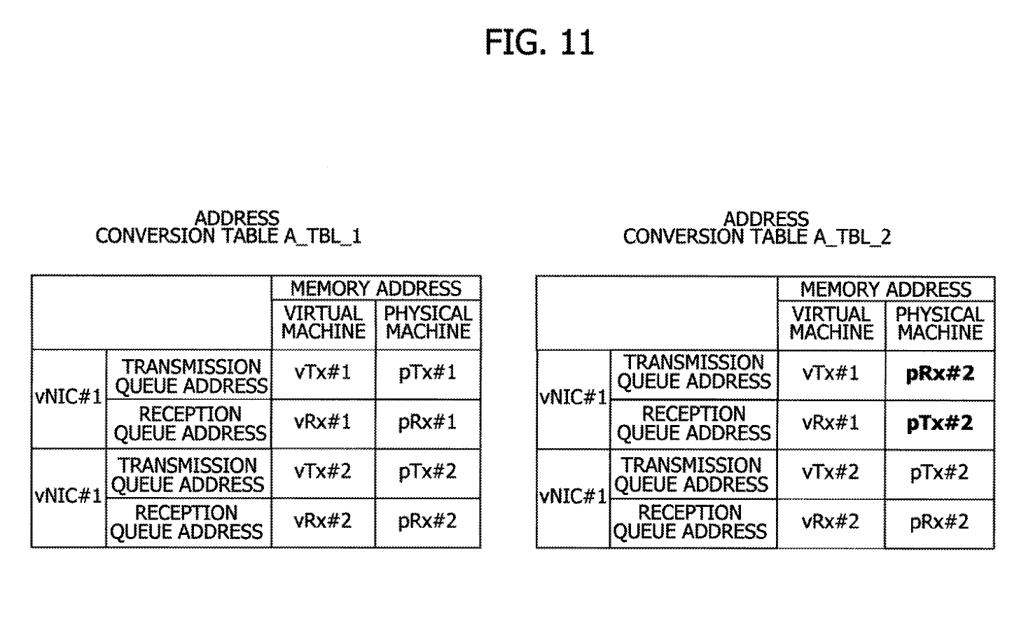

FIG. 11 is a diagram illustrating an example of an address conversion table of the transmission/reception queue. The host kernel creates an address conversion table A_TBL_1 illustrated on the left side of FIG. 11 as the address conversion table of the virtual machines VM#1 and VM#2. The address conversion table A_TBL_1 is the same as the tables A_TBL#1 A_TBL#2 illustrated in FIG. 8. As described in FIG. 8, the address conversion table maintains correspondence between a memory address of a virtual machine and a memory address of a physical machine with respect to transmission and reception queues used by each virtual NIC. Moreover, for example, when a virtual device driver virtio writes data to a memory address of a virtual machine, a host kernel HK of a physical machine converts the memory address of the virtual machine to a memory address of a physical machine by referring to the address conversion table and writes data to a physical memory of the physical machine.

As another preliminary process, the host kernel HK creates a virtual NIC information table when activating a virtual machine (S21).

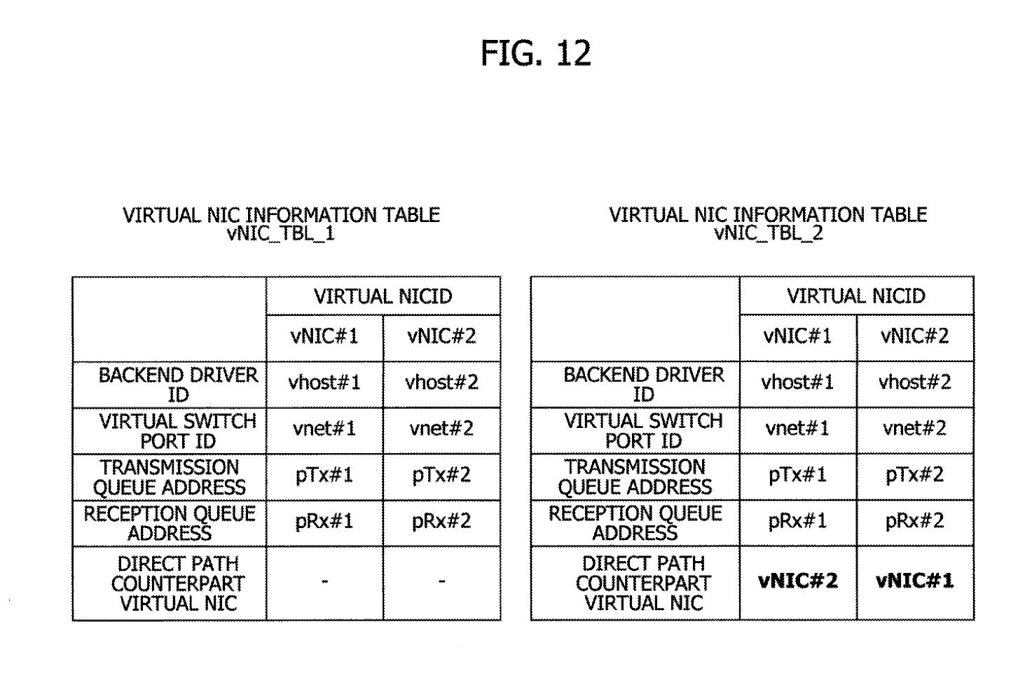

FIG. 12 is a diagram illustrating an example of a virtual NIC information table. The host kernel creates the virtual NIC configuration table vNIC_TBL_1 illustrated on the left side of FIG. 12. In this example, a virtual NIC (vNIC#1) is formed in the virtual machine VM#1, a virtual NIC (vNIC#2) is formed in the virtual machine VM#2, and backend drivers (vhost#1 and vhost#2) connected to the respective virtual NICs, the port IDs (vnet#1 and vnet#2) of the virtual switches connected to the virtual NICs, and the addresses (pTx#1, pRx#1, pTx#2, and pRx#2) of the physical machines, of the transmission and reception queues used by the virtual NICs are set. Furthermore, an entry (direct path counterpart virtual NIC) for storing the ID of a connection counterpart virtual NIC when a direct path is established is present, and it is assumed that the entry is not set at the time of activation.

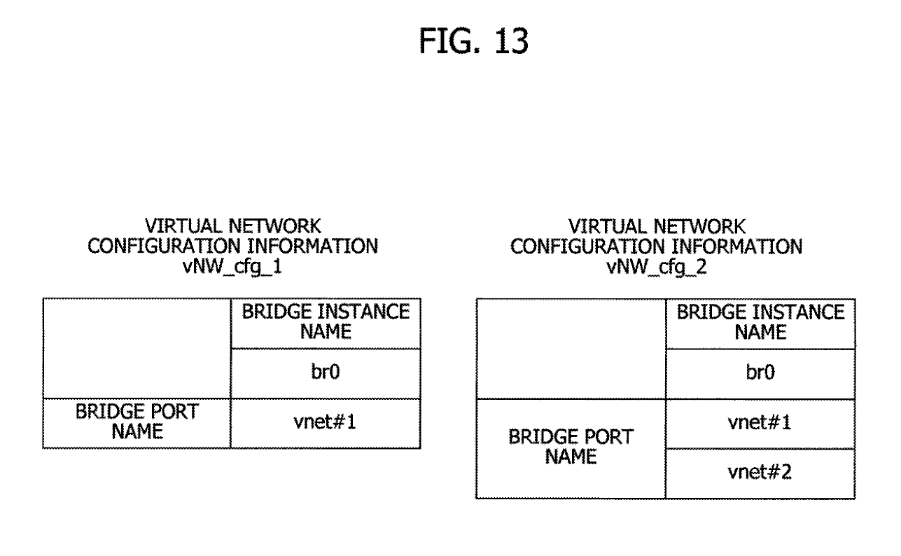

FIG. 13 is a diagram illustrating an example of virtual network configuration information of a virtual bridge. First, as illustrated in the virtual network configuration information vNW_cfg on the left side of FIG. 13, it is assumed that only the bridge port vnet#1 is bound to the virtual bridge instance br0. The setting of the virtual bridge instance is performed according to a setting command input by an administrator.

Returning to FIG. 10, the virtual NW change detection unit 31 always monitors a command to change the virtual network configuration information issued from an administrator (S22). Here, it is assumed that the administrator has input a setting command to bind the bridge port vnet#2 corresponding to the virtual NIC (vNIC#2) of the virtual machine VM#2 to the bridge instance br0 in the virtual network configuration information, to which the bridge port vnet#1 corresponding to the virtual NIC (vNIC#1) of the virtual machine VM#1 is already bound, in order to establish communication between the virtual machines VM#1 and VM#2.

Therefore, the virtual NW change detection unit 31 detects a command to change a virtual network (S23: YES). Upon detecting the input of a command to change the virtual network configuration information, the virtual NW change detection unit 31 acquires a change target bridge instance name br0 from the input command and notifies the direct path setting determining unit 32 of the bridge instance name br0.

In response to this notification, the direct path setting determining unit 32 determines whether the bound bridge port satisfies all of the following conditions by referring to the information on the bridge instance br0 of the virtual network configuration information.

(1) Only two bridge ports are bound to the bridge instance br0 (S24).
(2) The two bridge ports in (1) are connected to a virtual NIC (the port name starts with “vnet”) (S25).

A virtual NW configuration information vNW_cfg_2 on the left side of FIG. 13 is virtual NW configuration information changed by the command. The bridge instance br0 illustrated in the virtual NW configuration information vNW_cfg_2 has only two ports and the port names of the two ports are vnet#1 and vnet#2 connected to a virtual NIC. Therefore, the bridge instance br0 satisfies all of the two conditions (S24 and S25: YES), the direct path setting determining unit 32 determines that a direct path can be established between the virtual NICs corresponding to vnet#1 and vnet#2. This determination means that the direct path setting determining unit 32 has detected the setting of one-to-one communication between a first virtual machine and a second virtual machine of a common physical machine in the configuration information (the configuration information of the bridge instance br0) that includes transmission destination information of communication data between the ports of a virtual switch.

The direct path setting determining unit acquires virtual NICs (vNIC#1 and vNIC#2) corresponding to port IDs vnet#1 and vnet#2 from the virtual NIC information table (the table vNIC_TBL_1 on the left side of FIG. 12) and notifies the direct path creation and removal unit 33 of the fact that the direct path is to be set and the target virtual NICs (vNIC#1 and vNIC#2) (FIG. 10 illustrates the process of the host kernel, therefore the notification process is not illustrated).

Therefore, the direct path creation and removal unit 33 acquires pTx#2 and pRx#2 which are the addresses of the physical machines of the transmission and reception queues used by the virtual NIC (vNIC#2) from the virtual NIC information table (S30). Moreover, the direct path creation and removal unit 33 rewrites the addresses pTx#1, pRx#1 of the physical machines of the transmission and reception queues of the virtual NIC (vNIC#1) in the address conversion table A_TBL to the addresses pRx#2 and pTx#2 of the virtual NIC (vNIC#2) (S31) and sets vNIC#2 to the direct path counterpart virtual NIC of vNIC#1 and vNIC#1 to the direct path counterpart virtual NIC of vNIC#2, in the direct path counterpart virtual NICs in the virtual NIC information table vNIC_TBL (S32).

An address conversion table A_TBL_2 rewritten by the direct path creation and removal unit is illustrated on the right side of FIG. 11. The transmission queue address pTx#1 of the physical machine of the virtual NIC (vNIC#1) is rewritten to the physical reception queue address pRx#2 of the virtual NIC (vNIC#2), and the reception queue address pRx#2 of the physical machine of the virtual NIC (vNIC#1) is rewritten to the physical transmission queue address pTx#2 of the virtual NIC (vNIC#2). As a result, the physical transmission/reception queue pQUE#2 of the virtual NIC (vNIC#2) is shared between the virtual NICs (vNIC#1 and vNIC#2).

A virtual NIC information table vNIC_TBL_2 rewritten by the direct path creation and removal unit is illustrated on the right side of FIG. 12. The identifiers vNIC#2 and vNIC#1 of the counterpart virtual NICs are set to the fields of the direct path counterpart virtual NICs of the virtual NICs (vNIC#1 and vNIC#2).

After the address conversion table and the virtual NIC configuration table are changed by the direct path creation and removal unit, transmission of data between the virtual NICs (vNIC#1 and vNIC#2) of the virtual machines VM#1 and VM#2 is processed as below.

That is, upon receiving a transmission notification from the virtual NIC (vNIC#1) of the virtual machine VM#1, the hypervisor HV detects the setting of a direct path by referring to the virtual NIC information vNIC_TBL_2 (FIG. 12) of the notification source virtual NIC (vNIC#1) and issues a reception notification interrupt to the set direct path counterpart virtual NIC (vNIC#2) (S33 in FIG. 10 and S11 and S8 in FIG. 9). When the address conversion table A_TBL_2 is rewritten, as illustrated in FIG. 9, the transmission data of the virtual device driver virtio#1 of the virtual machine VM#1 is written to the reception queue (pRx#2) in the physical transmission/reception queue pQUE#2. Therefore, the virtual device driver virtio#2 of the virtual NIC (vNIC#2) having received the reception notification can read the reception data from the reception queue (pRx#2).

In contrast, upon receiving a transmission notification from the virtual NIC (vNIC#2) of the virtual machine VM#2, the hypervisor HV detects the setting of a direct path by referring to the virtual NIC information vNIC_TBL_2 of the notification source virtual NIC (vNIC#2) and issues a reception notification to the set direct path counterpart virtual NIC (vNIC#1).

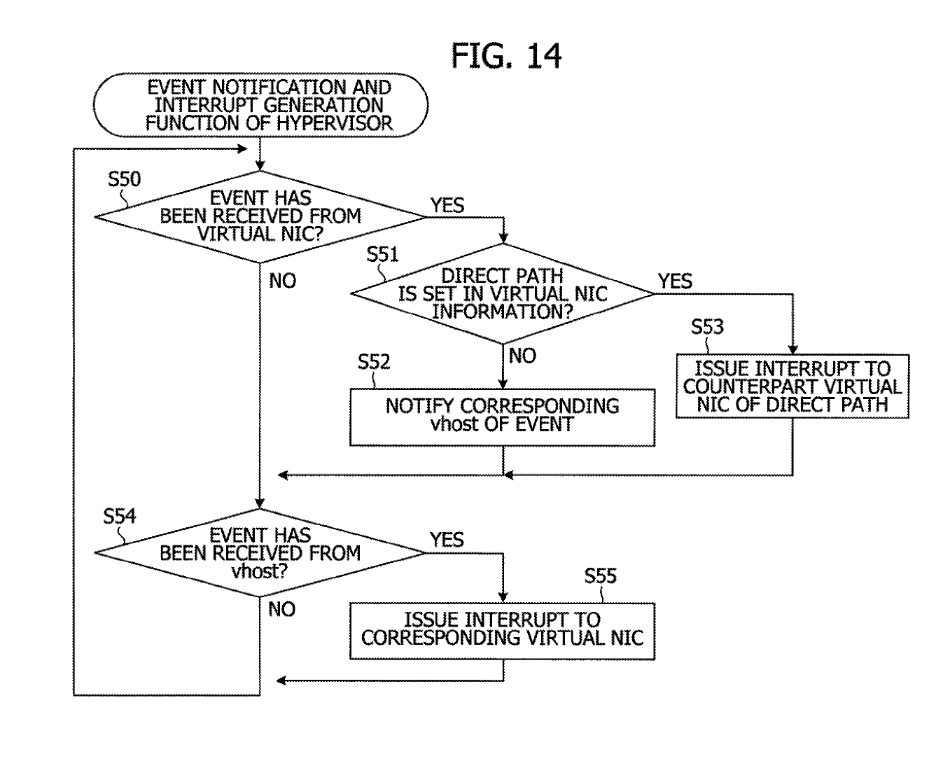

FIG. 14 is a flowchart of an event notification and interrupt generation function of a hypervisor according to the present embodiment. As described in FIG. 2, the event notification and interrupt generation function of the hypervisor notifies an event of a transmission notification from a virtual NIC to the backend driver vhost of a host kernel corresponding to the virtual NIC, and in response to a reception notification from a certain backend driver, issues a reception notification interrupt to a virtual NIC corresponding to the backend driver.

In contrast, the event notification and interrupt generation function of the present embodiment checks whether a direct path counterpart virtual NIC is registered by referring to a virtual NIC information table upon receiving an event of a transmission notification from a virtual NIC, notifies the event to a backend driver vhost of a host kernel corresponding to the virtual NIC if the direct path counterpart virtual NIC is not registered, and issues a reception notification interrupt to the direct path counterpart virtual NIC if the direct path counterpart virtual NIC is registered.

As illustrated in FIG. 14, upon receiving an event from a virtual NIC (S50: YES), the hypervisor checks whether a direct path is set in the virtual NIC information of the virtual NIC (S51). When the direct path is set, the hypervisor issues an interrupt corresponding to the event to a counterpart virtual NIC of the direct path (S53). When the direct path is not set, the hypervisor notifies the event to a backend driver corresponding to the virtual NIC which is a notification source of the event (S52). Upon receiving the event notification from the backend driver (S54: YES), the hypervisor issues an event interrupt to the virtual NIC corresponding to the backend driver which is the notification source (S55).

As described above, in the above-described embodiment, it is determined whether a one-to-one communication path (direct path) can be set between virtual NICs from the configuration information of a bridge instance. When the direct path can be set, an identifier of a counterpart virtual NIC of the direct path is set to the virtual NIC configuration table and the address conversion table is rewritten so that the same transmission and reception queues are shared between the virtual NICs. As a result, when a transmission notification is generated from one of the virtual NICs to which a direct path is set, the event notification and interrupt generation function of the hypervisor issues a reception notification interrupt to a counterpart virtual NIC of the direct path upon receiving the transmission notification from the virtual NIC without using the virtual bridge. In this way, the operation of the bridge is reduced, and the load on the host kernel that controls the bridge is reduced.

[Direct Path Removing Process]

Next, a direct path removing process will be described with reference to FIG. 10. It is assumed that a direct path is set between the virtual NIC (vNIC#1) and the virtual NIC (vNIC#2). Moreover, the address conversion table, the virtual NIC information table, and the virtual network configuration information are as illustrated on the right sides of FIGS. 11, 12, and 13.

Steps S20 and S21 of FIG. 10 are the same as those described above. The virtual NW change detection unit 31 always monitors a command to change the virtual network configuration information issued from an administrator (S23). Here, it is assumed that the administrator has input a setting command to disable the bridge port vnet#2 bound to the bridge instance br0 in the virtual network configuration information in order to disconnect the one-to-one communication between the virtual machines VM#1 and VM#2. As a result, with the setting command, the virtual network configuration information is changed to the table vNW_cfg_1 on the left side of FIG. 13.

Upon detecting the input of a command to change the virtual network configuration information (S23: YES), the virtual NW change detection unit 31 acquires a change target bridge instance name br0 from the input command and notifies the direct path setting determining unit 32 of the identifier br0.

Then, the direct path setting determining unit 32 determines that the following conditions (1) and (2) are not satisfied for the bound bridge port by referring to the information on the bridge instance br0 of the virtual network configuration information vNW_cfg_1 (S24: NO, S25: NO). Furthermore, the direct path setting determining unit 32 recognizes that a virtual NIC (vNIC#1) corresponding to the bridge port vnet#1 has established a direct path with another virtual NIC (vNIC#2) by referring to the virtual NIC information table (the table vNIC_TBL_2 on the right side of FIG. 12) (S40: YES) and notifies the direct path creation and removal unit 33 of the fact that the direct path is to be removed and the target virtual NICs (vNIC#1 and vNIC#2).

In response to this, the direct path creation and removal unit 33 acquires the addresses pTx#1 and pRx#1 which are the physical machine addresses of the transmission and reception queues used by the virtual NIC (vNIC#1) from the virtual NIC information table vNIC_TBL_2 (S41) and rewrites the physical machine addresses of the transmission and reception queues of the virtual NIC (vNIC#1) in the address conversion table A_TBL_2 to pTx#1 and pRx#1 (S42). Furthermore, the direct path creation and removal unit 33 removes the entries of the direct path counterpart virtual NICs in the virtual NIC information table (S43). As a result, the address conversion table is changed to the table A_TBL_1 on the left side of FIG. 11 and the virtual NIC information table is changed to the table vNIC_TBL_1 on the left side of FIG. 12.

With the above-described direct path removing process, an operation of transmitting data from the virtual machine VM#1 via the virtual NIC (vNIC#1) is performs as follows. First, when the virtual device driver virtio#1 of the virtual machine VM#1 writes transmission data to a transmission queue, the transmission data is written to the transmission queue (pTx#1) of the physical transmission/reception queue pQUE#1. Moreover, in response to the transmission notification from the virtual NIC (vNIC#1), the hypervisor HV checks that the virtual NICs (vNIC#1 and vNIC#2) have not established a direct path by referring to the virtual NIC information table vNIC_TBL_1 and issues a transmission request to a backend driver vhost#1 corresponding to the notification source virtual NIC (vNIC#1) (S44). The subsequent operations are the same as those described in FIGS. 2 and 8.

[Example in Which Virtual Switch is L3 Switch]

In the above-described embodiment, a virtual switch that forms a virtual network is a bridge which is an L2 switch and it is determined whether a one-to-one communication path (direct path) can be set between virtual NICs from the configuration information of a bridge instance. In contrast, in the following embodiment, an example in which a virtual switch that forms a virtual network is an L3 switch and it is determined whether a one-to-one communication path (direct path) can be set between virtual NICs from the flow information thereof.

Some virtual switches identify the flow of data in the virtual switch and determine the routing destination of the data for each flow like open virtual switches (Open vSwitch). Such a virtual switch maintains the flow information of data in addition to the above-described virtual network configuration information. For example, the example illustrated in FIG. 5 corresponds to this virtual switch.

In a physical machine which uses such a virtual switch, the direct path setting determining unit 32 determines whether a direct path can be set from the virtual network configuration information and the flow information. The operation of the above embodiment will be described as follows.

It is assumed that 192.168.10.1 is set to the virtual NIC (vNIC#1) of the virtual machine VM#1 illustrated in FIG. 7 as an IP address and 192.168.10.2 is set to the virtual NIC (vNIC#2) of the virtual machine VM#2 as an IP address.

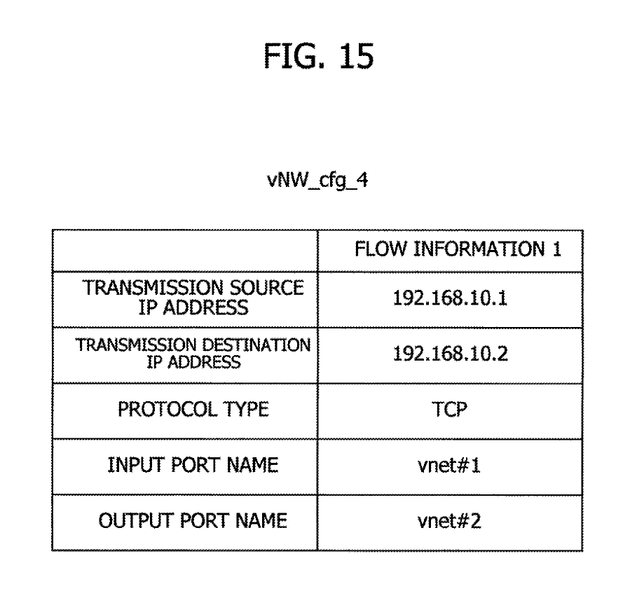

FIG. 15 is a diagram illustrating an example of virtual network configuration information of a virtual switch. When an administrator inputs a setting command for establishing communication between virtual machines VM#1 and VM#2, the following flow information is set as illustrated in FIG. 15.

Transmission source IP address: 192.168.10.1
Transmission destination IP address: 192.168.10.2
Protocol type: TCP
Input port name: vnet#1
Output port name: vnet#2
This flow information means that when a packet of which the protocol type is TCP, the transmission source IP address is 192.168.10.1, and the transmission destination IP address is 192.168.10.2 is input from the port name vnet#1, the virtual switch outputs (routes) the packet to the port name vnet#2.

Therefore, the virtual NW change detection unit 32 determines whether all of the following conditions are satisfied for ports represented by the input port name and the output port name by referring to all items of flow information in the virtual network configuration information.

(1) There is a port of which the input port name or the output port name appears only once (or once each) in all items of flow information in the virtual network configuration table of the virtual switch.
(2) There are ports which satisfy the condition (1) and each of the ports forms an input port name and an output port name respectively.
(3) The two ports in (2) are connected to a virtual machine (the port names start with “vnet” indicating that the ports are connected to a virtual machine).

In the example of the virtual network configuration information vNW_cfg_4 of FIG. 15, since all the three conditions are satisfied, the direct path setting determining unit 32 determines that a direct path can be set between the virtual NICs (vNIC#1 and vNIC#2) corresponding to the port names vnet#1 and vnet#2. This determination means that the direct path setting determining unit 32 has detected the setting of one-to-one communication between the first and second virtual machines of a common physical machine from the configuration information (the flow information) including the transmission destination information of the communication data between the ports of the virtual switches.

In contrast to FIG. 15, in the case of the virtual network configuration information vNW_cfg_3 illustrated in FIG. 5, the port name vnet#1 appears twice and port names vnet#2 and vnet#3 appear once each in the two items of flow information. However, the port names vnet#2 and vnet#3 are not set as a pair of input and output port names. That is, the condition (2) is not satisfied. As a result, in the example of the virtual network configuration information vNW_cfg_3 illustrated in FIG. 5, it is not possible to set a direct path between virtual NICs.

As described above, in the present embodiment, even when a virtual switch has a virtual switch configuration and flow information like an open virtual switch (Open vSwitch) if it is possible to set a direct path like an one-to-one communication path between virtual NICs, the direct path setting determining unit of the inter-VM direct path management program 30 of the host kernel detects that a direct path can be set, and the direct path creation and removal unit changes the address conversion table and sets a counterpart virtual NIC of the direct path to the virtual NIC information table. In this way, the hypervisor can control the communication path between virtual NICs without using a virtual switch.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing therein a communication control program for causing a computer to execute a process comprising:
detecting setting of one-to-one communication between a first virtual machine and a second virtual machine generated in a common physical machine in configuration information including transmission destination information of communication data between ports of virtual switches; and
setting, when the setting of the one-to-one communication is detected, a transmission buffer of the first virtual machine and a reception buffer of the second virtual machine to the same buffer area and setting a reception buffer of the first virtual machine and a transmission buffer of the second virtual machine to the same buffer area.

2. The non-transitory computer-readable storage medium according to claim 1, the process further comprising:
setting, when the buffers are set to the same buffer area, a second virtual network interface of the second virtual machine to configuration information of a first virtual network interface of the first virtual machine as direct transmission destination information and setting the first virtual network interface to configuration information of the second virtual network interface as direct transmission destination information.

3. The non-transitory computer-readable storage medium according to claim 2, wherein
the physical machine has an event notification and interrupt generation unit that transmits a transmission notification from the first virtual machine to a first backend driver, transmits a reception notification from a second backend driver to the second virtual machine, transmits a transmission notification from the second virtual machine to the second backend driver, and transmits a reception notification from the first backend driver to the first virtual machine, and
the event notification and interrupt generation unit transmits a transmission notification from one of the first and second virtual machines to the other virtual machine as a reception notification based on the direct transmission destination information set to the configuration information of the first or second virtual network interface.

4. The non-transitory computer-readable storage medium according to claim 2, wherein
the setting of the one-to-one communication includes setting of one-to-one communication between the first and second virtual network interfaces, and
the transmission buffer and the reception buffer set to the same buffer area have a transmission buffer and a reception buffer of the first virtual network interface and the second virtual network interface, respectively.

5. The non-transitory computer-readable storage medium according to claim 2, wherein
the configuration information of the virtual switch has a virtual bridge instance and information on a port bound to the virtual bridge instance, and
the setting of the one-to-one communication includes setting such that the port information of the virtual bridge instance in the configuration information of the virtual switch has only two ports and the two ports are connected to the first virtual network interface and the second virtual network interface, respectively.

6. The non-transitory computer-readable storage medium according to claim 2, wherein
the configuration information of the virtual switch has flow information of the communication data, including an input port and an output port, and
the setting of the one-to-one communication includes setting such that two ports which appear only once in the flow information forms a pair of the input port and the output port and the input port and the output port are connected to the first virtual network interface and the second virtual network interface, respectively.

7. A communication control method comprising:
detecting setting of one-to-one communication between a first virtual machine and a second virtual machine generated in a common physical machine in configuration information including transmission destination information of communication data between ports of virtual switches; and
setting, when the setting of the one-to-one communication is detected, a transmission buffer of the first virtual machine and a reception buffer of the second virtual machine to the same buffer area and setting a reception buffer of the first virtual machine and a transmission buffer of the second virtual machine to the same buffer area.

8. An information processing device comprising:
a processor; and
a memory coupled to the processor, wherein
the processor is configured to:
detecting setting of one-to-one communication between a first virtual machine and a second virtual machine generated in a common physical machine in configuration information including transmission destination information of communication data between ports of virtual switches; and
setting, when the setting of the one-to-one communication is detected, a transmission buffer of the first virtual machine and a reception buffer of the second virtual machine to the same buffer area and setting a reception buffer of the first virtual machine and a transmission buffer of the second virtual machine to the same buffer area.

9. The information processing device according to claim 8, wherein
the processor is further configured to:
setting, when the setting of the one-to-one communication is detected, a second virtual network interface of the second virtual machine to configuration information of a first virtual network interface of the first virtual machine as direct transmission destination information and setting the first virtual network interface to configuration information of the second virtual network interface as direct transmission destination information.

10. The information processing device according to claim 8, wherein
the physical machine has an event notification and interrupt generation unit that transmits a transmission notification from the first virtual machine to a first backend driver, transmits a reception notification from a second backend driver to the second virtual machine, transmits a transmission notification from the second virtual machine to the second backend driver, and transmits a reception notification from the first backend driver to the first virtual machine, and
the event notification and interrupt generation unit transmit a transmission notification from one of the first and second virtual machines to the other virtual machine as a reception notification based on the direct transmission destination information set to the configuration information of the first or second virtual network interface.
